(19) United States
(12) Patent Application Publication
(10) Pub. No.: US 2014/0085886 A1
(43) Pub. Date: Mar. 27, 2014

(54) Light, Especially Headlights

(71) Applicant: COBRA electronic GmbH & Co. KG, Ingolstadt (DE)

(72) Inventor: Georg Kothmeier, Ingolstadt (DE)

(73) Assignee: COBRA electronic GmbH & Co. KG, Ingolstadt (DE)

(21) Appl. No.: 14/034,786

(22) Filed: Sep. 24, 2013

(30) Foreign Application Priority Data
Sep. 24, 2012 (DE) 20 2012 103 660.6

(51) Int. Cl. F21V 5/00

(52) U.S. Cl. CPC F21V 5/007
USPC 362/237

(57) ABSTRACT

The invention refers to a light, especially a spotlight (6, 16) as lighting source in the application area of budding monitoring, with at least one closed housing (7, 7a, 7b), in which there are at least one light emitting diode (2) arranged on a circuit board (1), a converging lens (3) assigned to one of each aforesaid light emitting diodes (2) and at least one dispersing lens (4, 4, 4″) that can be assigned to one of each aforementioned light emitting diodes (2), in which case every one of the converging lenses (3) collects the emitted light of the light emitting diode (2) assigned to it and directs it to one dispersing lens assigned to one of these light emitting diodes (2) in case of need, in which case this dispersing lens (4, 4′, 4″) emits the light it absorbed into a distant field (F), and in which case the ad hoc assignment of the dispersing lens (4, 4′, 4″) is made possible with closed housing (7, 7a, 7b).

This invention refers to a lamp, especially a spotlight, used as lighting source in the application area of building security.

Lights and spotlights, in which the generated light, especially the one generated by light emitting diodes (LEDs), is beamed in one direction by means of a lamp by focusing or scattering light rays through reflection or refraction, but also using optical lenses, are known from state of the art in numerous designs for the most varied applications—for example, for emphasizing a floodlit object. In this process, a reflector generally focuses the light, which comes out either scattered or focused depending on the position, form and combination of the optical lenses. Usually, the individual elements of a lamp or spotlight are enclosed in a housing.

So-called LED spotlights work with many individual light emitting diodes, which themselves have a converging lens for focusing the emitted light. The bundling of these light emitting diodes, which can be about 10°, for example, cannot generally be changed. Larger LED spotlights, in particular, need a cooling body to cool the temperature-sensitive light emitting diodes sufficiently. Groups of light emitting diodes are connected together in series and, in turn, now and then in parallel to form a so-called array supplied by a constant power source. To adjust them to the operating voltage and operating current, electronic circuits, switching regulators, with mains-operated spotlights connected in series, rectifiers and smoothing capacitors and similar electronic equipment are especially used for controlling brightness or the like.

So-called LED infrared spotlights work with near infrared emitting light emitting diodes (infrared LEDs) and are used especially in the application area of building monitoring as lighting source for security cameras. An infrared LED or infrared diode is a light emitting diode that emits light with a wavelength ranging from about 700 nm to about 1000 nm. This range of the light spectrum is invisible to the human eye, but can be measured with radiation detectors made of pyroelectric materials or semiconductors, for example with photo diodes or photo transistors used in the corresponding infrared-sensitive security cameras.

In the application area of building monitoring as lighting source, it is especially necessary to monitor such lights and spotlights for the light being emitted into a distant field to adapt them to the given requirements and conditions so an optimal illumination of the area to be monitored can be ensured. To accomplish this, dispersing lenses are used in the corresponding lights and spotlights whose purpose is to allow an enlargement of the light focused by the converging lenses that is emitted by the light emitting diodes.

The solutions for the use and handling of dispersing lenses known to date have various disadvantages. The adjustment options and ranges of the attainable beam angles are limited, in particular, by the dispersing lenses. Even if a fundamental possibility presents itself to assign various dispersing lenses to the light emitting diodes—which is already disadvantageous in terms of cost because of the dispersing lenses—the assignment to the respective adjustment of the required or necessary beam angle is especially time consuming in practice and often poses the risk of incorrect handling that could lead to damaged lights and spotlights.

Generally, such a beam angle adjustment is done for a local area to be illuminated with lights or spotlights usually mounted or installed in positions not easily accessible to the public, particularly to prevent damage caused by vandalism or manipulation by persons. To date, in order to adjust the beam angles, the housings of the installed lights and spotlights must be opened on site and closed once again after the adjustment. Since the lights and spotlights on site are usually difficult to access, this is a difficult and time consuming undertaking, especially in the case of infrared spotlights that necessitate such an adjustment in the dark. Often, the housings of the lights and spotlights are not correctly closed again or damaged. Humidity or water can then penetrate into the leaky housing, especially if it has been installed in the open, and this can lead to the destruction of the electronic circuits and therefore of the light and spotlight, especially of the temperature-sensitive light emitting diodes.

Against this background, the present invention has the task to improve the way the beam angles of lights and spotlights are adjusted and, in particular, to carry out this task more easily. and cheaply.

The technical solution suggests a light, especially a spotlight used as lighting source in the application area of building monitoring, with at least one closed housing, in which at least one such light emitting diode is arranged on a circuit board, a converging lens assigned to each light emitting diode mentioned above and at least one dispersing lens that can be assigned to each aforesaid light emitting diode, in which case every one of the converging lenses collects the emitted light from the light emitting diode correspondingly assigned to it and directs it to one of the dispersing lenses assigned to this light emitting diode in case of need. This dispersing lens emits the light it absorbed into a distant field and the ad hoc assignment of the dispersing lens is made possible with a closed housing.

With the closed housing, the invention advantageously considers an ad hoc assignment of a dispersing lens and therefore a utilization of several dispersing lenses that preferably allow different beam angles, in which case advantageously only one assignment of one of the several possible dispersing lenses that can be assigned takes place.

Advantageously, the at least one dispersing lens in the housing is contained by a holding or supporting element arranged so it can be twisted or displaced that for the ad hoc allocation of the dispersing lens can be preferably twisted or displaced in such a way that the optical axis of the dispersing lens and the optical axis of the converging lens can be aligned largely congruently. This means, in particular, that the at least one dispersing lens assigned on an ad hoc basis can be advantageously arranged or positioned coaxially in an essentially parallel way to the plane on which the converging lens lies.

A preferred embodiment of the invention provides that the holding or supporting element can be twisted or displaced by means of a magnet. Such a twisting or displacement of the holding or supporting element having at least one dispersing lens can advantageously take place from outside when the light housing is closed because a magnet and/or a body (preferably made of metal) acting together with the magnet is twisted or displaced outside on the housing and thus brings about the twisting or displacement of the holding or supporting element. The magnet and/or the body acting together with the magnet can advantageously be placed merely outside, on top of the housing, and be correspondingly twisted or displaced.

Another advantageous embodiment of the invention is characterized by a preferably twist-protected mounting of the holding or supporting element with a spring element or by a displacement-protected mounting of the holding or supporting element. This advantageously ensures that a performed assignment of a dispersing lens can be maintained or retained and furthermore a secure assignment of the dispersing lens.

Another preferred embodiment of the invention provides that the holding or supporting element arranged so it can be twisted or displaced is executed essentially in the form of a perforated disk and at least two dispersing lenses are arranged on the perforated disk or are executed in or by it, so that, in particular, dispersing lenses with different beam angles can be used. In this case, the invention is advantageously based on the premise that, depending on the number n1 of dispersing lenses of a perforated disk n1 according to the invention, adjustment possibilities for various beam angles of a light emitting diode are made possible.

Advantageously, the dispersing lenses are preferably arranged uniformly across the circumference of the perforated disk distributed on the perforated disk or executed in or by it, in which case the perforated disk is mounted in the center of the perforated disk. According to the invention, another embodiment—in which instead of one of the dispersing lenses, no dispersing lens is provided in one of the holes of the perforated disk—is possible, so that there is the possibility of using the beam angle given by the converging lens. As a result of this, the beam angle range of the light according to the invention can be changed further.

A specific embodiment of the invention provides that the perforated disk in or on the center of the perforated disk has a magnet or a body, preferably made of metal, that acts together with the magnet.

Another especially advantageous embodiment of the invention provides that the at least one dispersing lens is a foil lens. The use of foil lenses allows an especially economical and lightweight design.

Advantageously, the at least one light emitting diode emits infrared light, visible light or ultraviolet light.

The at least one housing is advantageously executed to protect it against humidity or splashing water.

An specially preferred embodiment of the spotlight according to the invention has at least two and preferably many light emitting diodes arranged on a circuit board that are preferably fully connected in series to carry out an adjustment to the operating voltage and operating current. Here, one converging lens has been assigned to each light emitting diode and at least one of the light emitting diodes can be assigned to a dispersing lens, in which case the converging lenses collect the light emitted by the corresponding light emitting diode and emit it either into a distant field or—if at least one dispersing lens can be assigned to one of the light emitting diodes—direct it to one of the dispersing lenses assigned to one of the light emitting diodes assigned on an ad hoc basis, which emits the light it absorbed to a distant field. According to the invention, the ad hoc allocation of the dispersing lens in a closed housing is likewise made possible here.

Depending on the number n1 of dispersing lenses of a perforated disk according to the invention, n1 adjustment possibilities for various beam angles of a light emitting diode are made possible in this case. Depending on the number n2 of perforated disks for a number n2 of light emitting diodes, with a number n1 of dispersing lenses for each one of the perforated disks, there are, advantageously according to the invention, a corresponding n1 to the power of n2 adjustment possibilities for different emission ranges of a spotlight according to the invention are made possible, in which case n1 and n2 are larger than 1.

An especially preferred embodiment of the spotlight according to the invention provides that the perforated disk is executed in an essentially triangular shape with rounded corners and a dispersing lens is arranged on each corner of the perforated disk or is executed in or by it, in which case the dispersing lenses have preferably different scattering angles. Thus, if five (n2) light emitting diodes having in each case such a perforated disk with three (n1) light emitting diodes having different dispersing lenses corresponding to three to the power of 5, i.e. 3 times 3 times 3 times 3 times 3, equals 243 adjustment possibilities for various emission ranges of a spotlight according to the invention.

From the above description, we learn that the light, especially spotlight, according to the invention can have numerous diodes and corresponding converging lenses, dispersing lenses that can be assigned as well as holding or supporting elements executed as perforated disks. The former are preferably executed as described above and as stated in the claims.

Advantageously, from the numerous light emitting diodes, at least one of them emits infrared light, visible light or ultraviolet light. By using various diodes that emit different light, it is possible to improve even more the lighting options offered by the spotlight according to the invention.

Another specific embodiment of the invention provides that the light emitting diodes of the spotlight are mutually separated and arranged beside one another in a row, in which case no dispersing lens can be assigned to the two outer light emitting diodes of the row.

An additional specific embodiment of the invention provides that the spotlight is provided with at least one supporting arm for carrying at least one housing, preferably two housings, executed preferably for mounting to a wall or ceiling, on which at least one movably-mounted housing is fastened to.

Advantageously, the supporting arm is executed in a vandal-proof way. The at least one housing is advantageously executed to be vandal-proof and/or protected against humidity or splashed water.

Further details, characteristics and advantages of the invention are explained in more detail below with the help of the drawings shown in the figures that represent the embodiments of the invention:

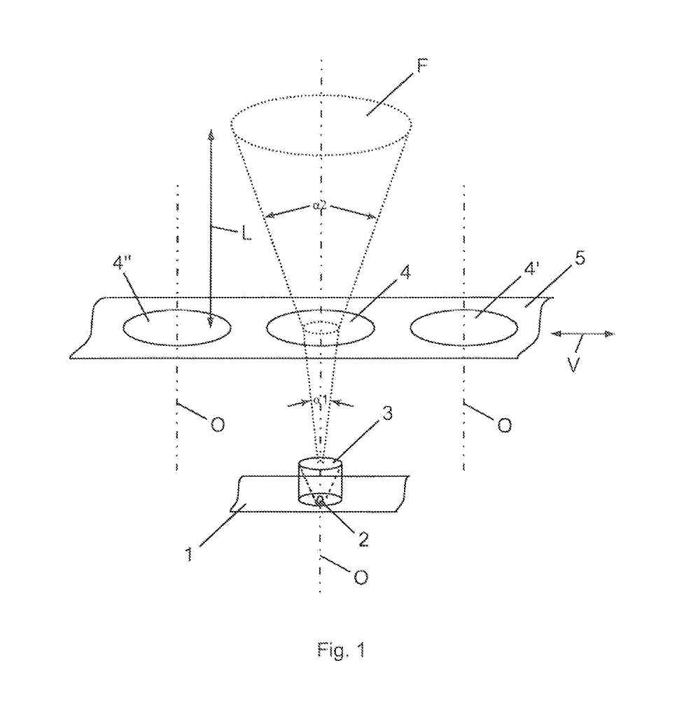

FIG. 1 a schematic representation of the basic working principle of a light according to the invention;

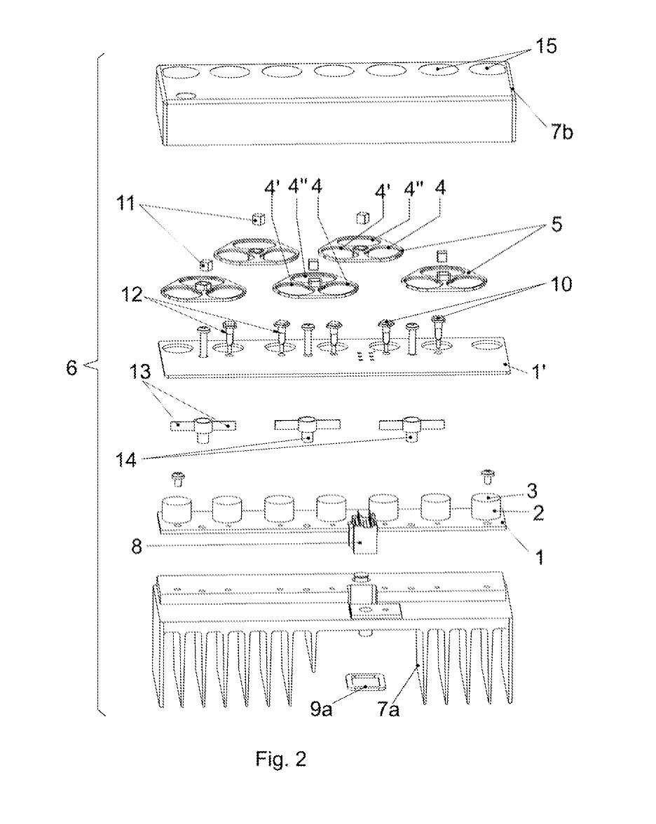

FIG. 2 a schematic exploded view in perspective of an embodiment of a spotlight according to the invention;

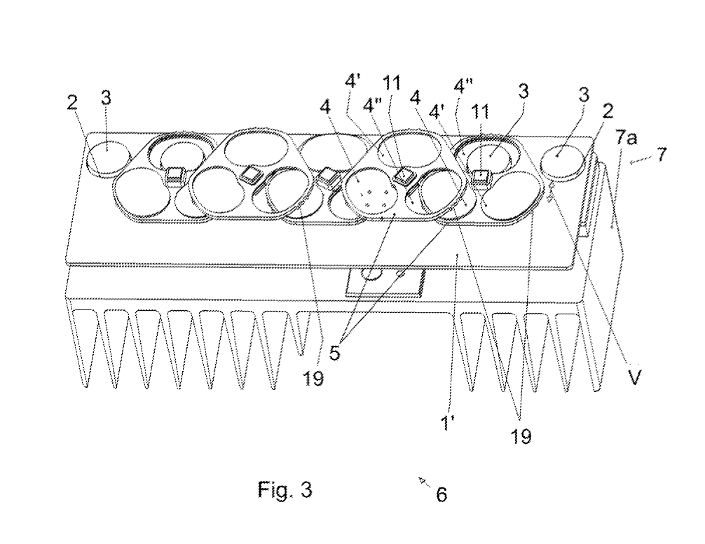

FIG. 3 a schematic view in perspective of the spotlight according to the invention shown in FIG. 2;

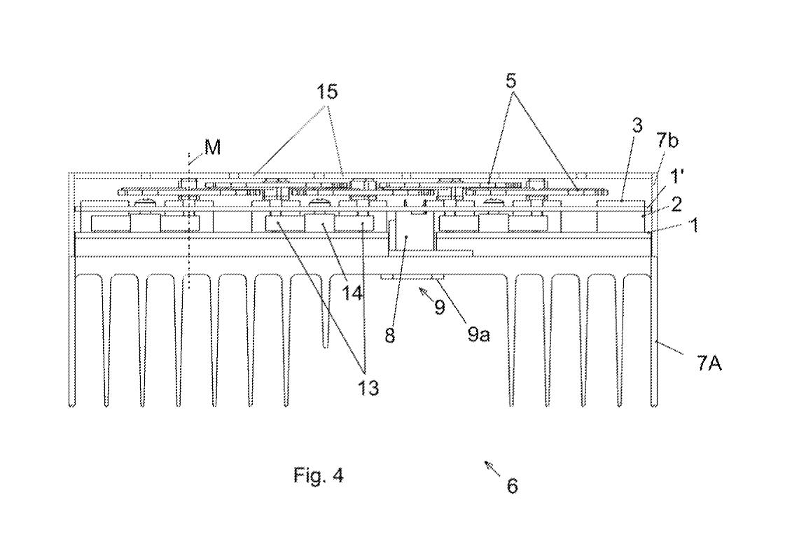

FIG. 4 a schematic lateral view of the spotlight according to the invention shown in FIG. 3;

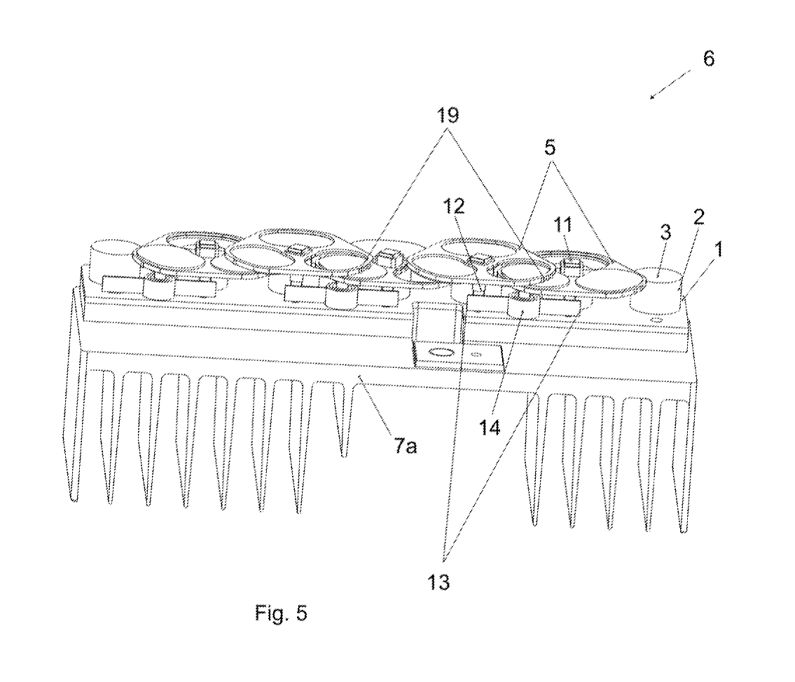

FIG. 5 an additional schematic view in perspective of the spotlight according to the invention shown in FIG. 3 with open housing;

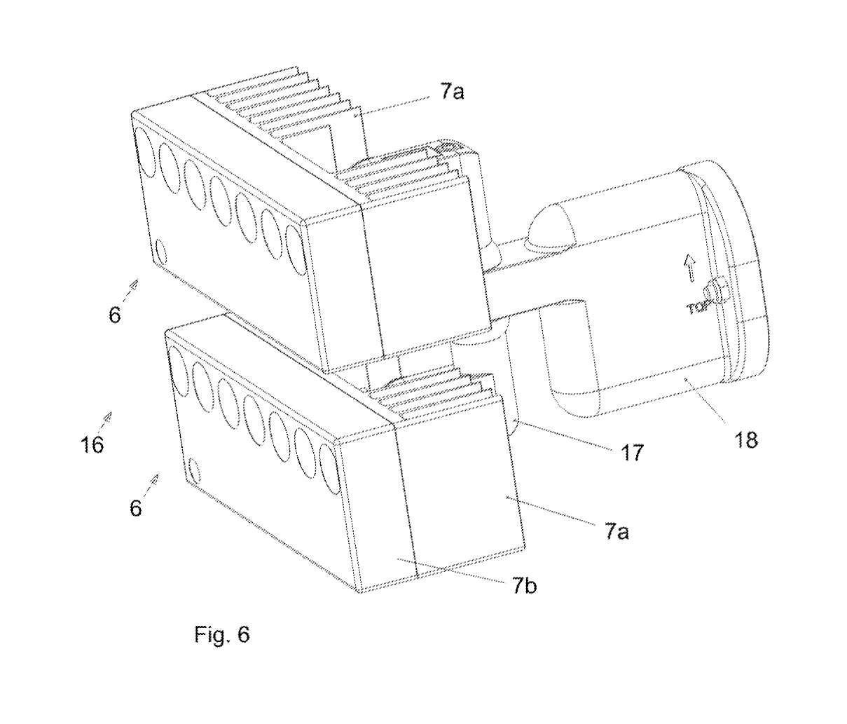

FIG. 6 a schematic view in perspective of a further embodiment of the spotlight according to the invention;

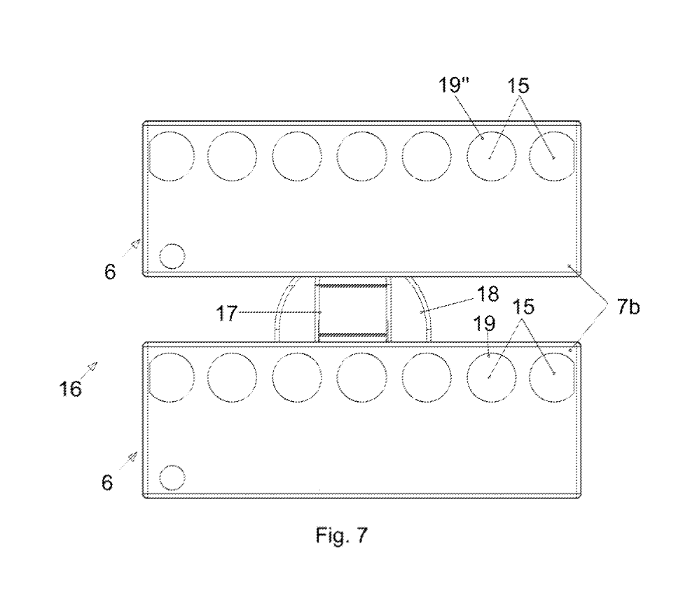

FIG. 7 a schematic frontview of the front of the spotlight according to the invention shown in FIG. 6;

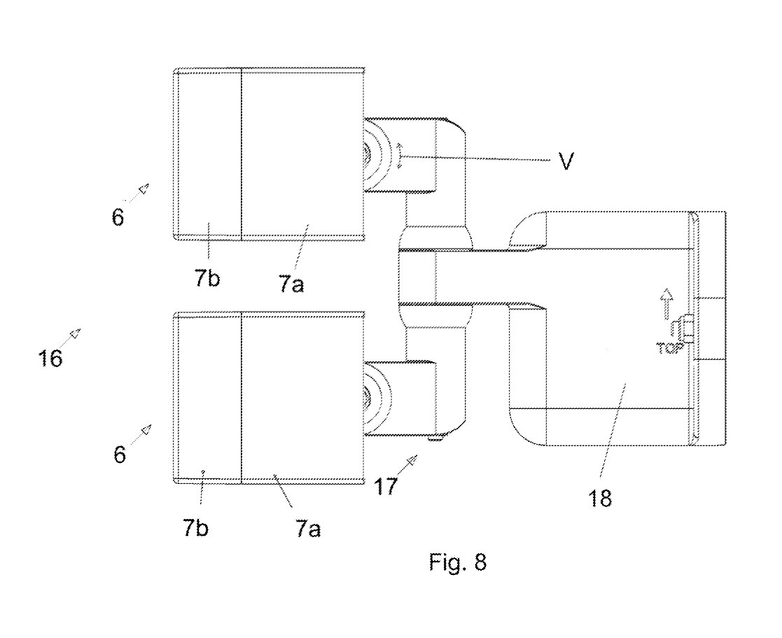

FIG. 8 a schematic lateral view of the spotlight according to the invention shown in FIG. 6;

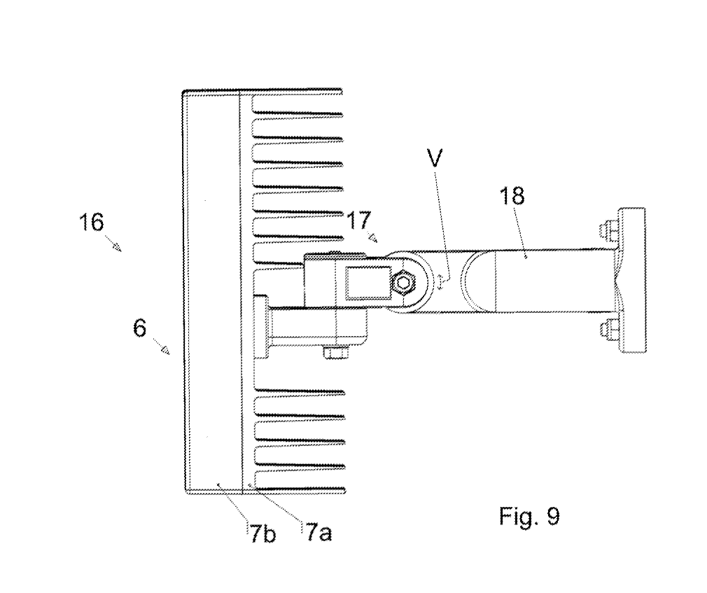

FIG. 9 an additional schematic lateral view of the spotlight according to the invention shown in FIG. 6; and

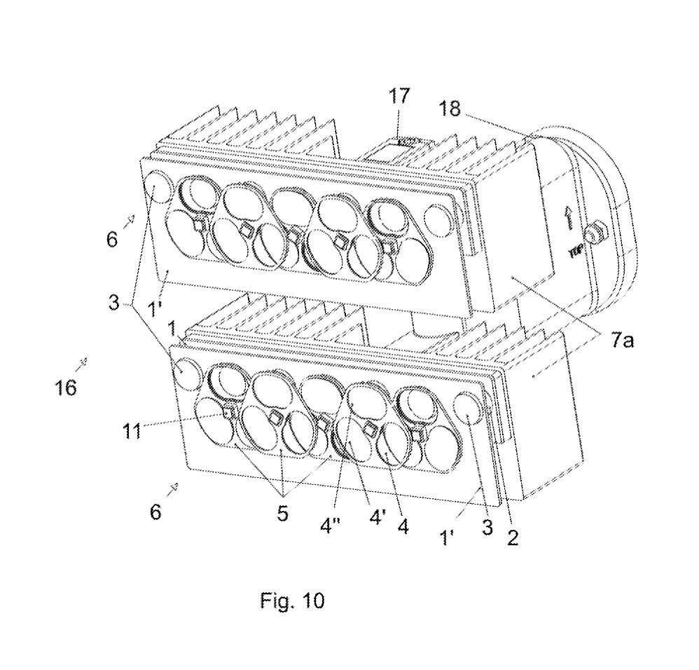

FIG. 10 an additional schematic view in perspective of the spotlight according to the invention shown in FIG. 6, with open housings.

FIG. 1 shows in a fundamental representation the basic working principle of a light according to the invention, in which a light emitting diode 2 is arranged in a closed housing 8 (not shown in FIG. 1) on a circuit board 1. A converging lens 3 is firmly assigned to the light emitting diode 2. The converging lens 3 collects the light emitted by the light emitting diode 2 with a beam angle of about 80° to 90° (not shown in FIG. 1) and focuses it with beam angle α1 of approx. 8° to 12°, for example. The light that the converging lens 3 correspondingly collects and focuses is then directed to a dispersing lens 4 assigned to the light emitting diode 2 or the converging lens 3 firmly assigned to it. The dispersing lens 4 subsequently disperses the light coming from the converging lens 3 with beam angle α1 to a beam angle α2 of about 35°, for example, to a distant field F, which lies in the area to be illuminated that can be, for example a budding area that needs to be monitored. The emission of the light with beam angle α2 absorbed by the dispersing light 4 has a luminous range L that depends on the dispersing lens 4 and its beam angle α2, and can reach up to 150 m, for example. In the light according to the invention, the light emitting diode 2 or the converging lens 3 firmly assigned to it, at least one dispersing lens 4 can be assigned.

The assigning of at least one dispersing lens 4 is shown symbolically in FIG. 1 by the additional dispersing lenses 4 marked with reference signs 4′ and 4″. Here, the dispersing lenses 4, 4′ and 4″ have different beam angles α2 and in the example shown in FIG. 1, they are arranged beside one another and mutually separated by a holding or supporting element 5 executed as perforated strip. The assignment of one of the dispersing lenses 4, 4′ and 4″ is shown in FIG. 1 by the double arrow given the reference sign V, which in FIG. 1 symbolizes a displacement of the holding or supporting arm 5 executed as perforated strip. Here, a displacement of the holding or supporting arm 5 executed as perforated strip causes an ad hoc assignment of one of the assignable dispersing lenses 4, 4′ or 4″ that in the light according to the invention is made possible with a closed housing. The assignment takes place in such a way that in one assigned dispersing lens 4 of the assignable dispersing lenses 4, 4′ or 4″, the optical axis O of the assigned dispersing lens (in FIG. 1 the dispersing lens 4) and the optical axis O of the converging lens 3 are aligned or positioned essentially congruently.

FIGS. 2 to 5 show a spotlight 6 executed especially as lighting source for use in the application area of building monitoring. The spotlight 6 has a closed housing 7 that is especially protected against humidity or splashed water, formed by a cooling body 7a with various cooling ribs in the bottom of the housing 7 and a bow-shaped lid 7b (shown only in FIG. 4, compare also the embodiment according to FIG. 6-10). Many light emitting diodes 2 are arranged on a circuit board 1 of the spotlight 6, here a total of seven mutually separated light emitting diodes 2 arranged in a row. In this case, one converging lens 3 is firmly assigned to the light emitting diodes 2. The circuit board 1 is fastened with screws onto the cooling body 7a executed on the bottom of the housing 7. The circuit board is executed in two parts and furthermore has a circuit board indicated by the reference sign 1′ arranged above the circuit board 1 and has recesses for the light emitting diodes 2 and their firmly assigned converging lenses 3. Here, the circuit board 1′ has electronic circuits and similar electronic hardware, especially for adjustment to the operational voltage and the operating current, indicated in FIGS. 2 and 4 with reference sign 8. It can especially recognized in FIG. 4 that for connecting the spotlight 6 to the mains, a corresponding recess 9 in the cooling body 7a sealable with a seal 9a is provided. In the housing lid 7b, viewing windows 15 have been executed in the areas of the light emitting diodes (shown only in FIG. 4, compare also the embodiment according to FIG. 6-10) through which the light emitted by the dispersing lenses 4, 4′ or 4″ can pass through. Here, the viewing windows 15 are preferably executed directly in the housing lid 7b or arranged in it in a sealed way. Furthermore, the viewing windows 15 themselves can also be an optical element, especially an optical filter, an optical lens or the like. Regarding the required wavelength of the light emitted by the light emitting diodes, the viewing windows 15 are indicated as such. This means that the light emitted with the corresponding wavelengths can pass through. The wavelength range must not necessarily be visible for human beings.

As can be seen in FIGS. 2 to 5, a holding or supporting element 5 executed largely as a triangular perforated disk rotatably mounted in the center has been assigned to the five light emitting diodes 3 in the center of the total of seven light emitting diodes 2 spaced apart from one another and arranged beside one another in a row with firmly assigned converging lenses 3. In this case, the perforated disk formed by the holding or supporting element 5 has three dispersing lenses 4, 4′, 4″ uniformly distributed over the circumference of the perforated disk, executed preferably as foil lenses. The dispersing lenses 4, 4′, 4″ can be assigned in case of need to a corresponding light emitting diode 2 with a firmly assigned converging lens 3 through twisting V (symbolically shown by the double arrow indicated with the reference sign V (cf. FIG. 3)) of the perforated disk forming the holding or supporting element 5. The dispersing lenses 4, 4′, 4″ have different scattering angles or beam angles.

The movable mounting of the holding or supporting elements 5 is done with bearing pins 10, movably mounted with one end in bore holes of the cooling body 7a that forms the housing bottom. On the opposite end of the bearing pins 10, the holding or supporting elements 5 of the dispersing lenses 4, 4′, 4″ executed as perforated disk are contained with or in their center M. On the side of the perforated disk 5 opposite the bearing pin 10, there is in or on the center M of the perforated disk 5 a quadrangular recess made of metal for containing a correspondingly quadrangular magnet 11 or a body 11 acting together with a magnet. The bearing pins 10 have a likewise triangular contour 12 in an area below the holding or supporting elements 5 executed as perforated disk, aligned with or to the presently essentially triangular design of the perforated disk 5, so that the edges of the perforated disk 5 and the edges of the contour 12 of the bearing pins run parallel to one another. Here, the contour 12 of the bearing pins 10 acts together with a springy lever arm 13 to provide twisting protection for the perforated disk 5. Advantageously, the holding or supporting elements 5 executed as perforated disk have markings 19, 19′ and 19″ executed in this case as elevations or recesses advantageously visible through the viewing windows 15 in the housing lid 7b (cf. especially FIGS. 3 and 7). The lever arms 13 are executed on a mounting element 14 fastened onto the circuit board 1 with screws to prevent twisting. If the housing 7 is closed, the holding or supporting elements 5 executed as perforated disk can be individually twisted with a magnet or with a metallic element acting together with the magnet 11 of the perforated disk placed or held outside on the housing in the area of the centers M of the perforated disks. In doing so, the correspondingly adjusted dispersing ens 4, 4′ or 4″ can be determined for the assignment by means of the markings 19, 19′ and 19″ visible through the viewing windows 15. According to the invention, the twisting allows an ad hoc assignment of one of the dispersing lenses 4, 4′, 4″ of the perforated disk.

In the embodiment of a spotlight 16 shown in FIGS. 6 to 10, two spotlights 6 according to FIGS. 2 to 5 have been mounted on a supporting arm 17 so they can be adjusted or swiveled. Here, the spotlights 6 can be adjusted or swiveled independently from one another around two axes, as can be seen by means of the double arrows indicated with the reference sign V in FIGS. 8 and 9. The supporting arm 17 has a connecting flange 18 for mounting it to the wall, ceiling or the like and has been executed in a vandal-proof way.

The embodiments of the invention described in connection with the drawings shown in the figures serve merely to explain the invention and do not restrict them.

### LIST OF REFERENCE CHARACTERS

1, 1′ Circuit board
2 Light emitting diode
3 Converging lens
4, 4′, 4″ Dispersing lens
5 Holding or supporting element (perforated strip or perforated disk)
6 Spotlight
7 Housing
7a Housing bottom/cooling body
7b Housing lid
8 Electronic circuits/electronic system
9 Recess for mains connection
9a Seal
10 Bearing pin
11 Magnet/Body
12 Contour bearing pin (10)
13 Lever arm (twist protection)
14 Lager element (lever arm (13))
15 Viewing window (housing lid (7b))
16 Spotlight
17 Supporting arm
18 Connection flange (supporting arm (17))
19, 19′, 19″ Marking dispersing lens (4, 4, 4″)
F Distant field
L Luminous range
M Center of holding or supporting element (5)
O Optical axis
V Twisting or displacement
α1 Beam angle of converging lens
α2 Beam angle of dispersing lens

1. Light, especially spotlight (6, 16), as lighting source in the application area of building monitoring, with at least one closed housing (7, 7a, 7b), in which there are at least one light emitting diode (2) arranged on a circuit board (1), a converging lens (3) assigned to one of each aforesaid light emitting diodes (2) and at least one dispersing lens (4, 4′, 4″) that can be assigned to one of each aforementioned light emitting diodes (2),
in which case every one of the converging lenses (3) collects the emitted light of the light emitting diode (2) assigned to it and directs it to one dispersing lens assigned to one of these light emitting diodes (2) in case of need,
in which case this dispersing lens (4, 4″, 4″) emits the light it absorbed into a distant field (F), and
in which case the ad hoc assignment of the dispersing lens (4, 4′, 4″) is made possible with closed housing (7, 7a, 7b).

2-15. (canceled)
